(19) United States
(12) Patent Application Publication
(10) Pub. No.: US 2011/0139424 A1
(43) Pub. Date: Jun. 16, 2011

(54) HEAT EXCHANGER

(76) Inventors: Thomas Bensel, Ditzingen (DE); Hicham Rouhana, Korntal-Muenchingen (DE); Haymo Broeder, Leonberg (DE)

(21) Appl. No.: 12/965,461

(22) Filed: Dec. 10, 2010

Related U.S. Application Data
(63) Continuation of application No. PCT/EP2009/003847, filed on May 29, 2009.

(30) Foreign Application Priority Data
Jun. 10, 2008 (DE) 10 2008 027 551.4
Oct. 21, 2008 (DE) 10 2008 052 590.1

(51) Int. Cl. F28F 9/02; B23P 15/26

(52) U.S. Cl. 165/173; 29/890.052

(57) ABSTRACT

A heat exchanger, especially a heat exchanger for a motor vehicle, is provided that includes a plurality of tubes, at least one collecting tube with a wall and openings in the wall, supports protruding from the wall in the axial direction of the openings being formed at the openings. Wherein the tubes in the region of one end of the tubes are disposed partly at the supports and a fluid-tight connection exists between the supports and the tubes, so that a fluid can be passed through the tubes and the at least one collecting tube, and at least one inlet opening for passing the fluid in and at least one outlet opening for passing the fluid out. The mechanicals stability between the tubes and the at least one collecting tube is to be improved. This objective is accomplished owing to the fact that the thickness of the supports is less than the thickness of the wall, especially in the region of the openings of the collecting tube.

This nonprovisional application is a continuation of International Application No. PCT/EP2009/003847, which was filed on May 29, 2009, and which claims priority to German Patent Application Nos. DE 10 2008 027 551.4, which was filed in Germany on Jun. 10, 2008, and to DE 10 2008 052 590.1, which was filed in Germany on Oct. 21, 2008, and which are herein incorporated by reference.

### BACKGROUND OF THE INVENTION

1. Field of the Invention

The invention relates to a heat exchanger and to a method for manufacturing a heat exchanger. The invention also relates to a motor vehicle air conditioning system.

2. Description of the Background Art

Heat exchangers are used to transfer heat from one fluid to another fluid. For example, heat is transferred from a cooling liquid to the ambient air by a heat exchanger. This is used, in particular, in motor vehicles, in which the heat exchanger is used to discharge the waste heat released by the internal combustion engine into the ambient air. The heat exchanger generally includes two collecting tubes, between which a plurality of tubes is disposed. Openings into which the tubes empty are introduced into the collecting tubes. The tubes are connected to the openings in the collecting tubes in a fluid-tight manner.

The openings in the collecting tubes are produced by through-stamping or puncturing. In through-stamping a wall of the collecting tube, the opening is through-stamped in such a way that the subarea of the wall which will form the later opening is removed. The surface supporting the tubes in the openings in the collecting tubes thus corresponds to the thickness of the wall of the collecting tube in the area of the opening. In puncturing the openings through the wall of the collecting tube, an annular passage, which corresponds to the deformed wall of the collecting tube in the subarea, forms at the openings. The subarea is the area of the collecting tube wall which corresponds to the opening after the latter is produced. The passage corresponding to the wall of the collecting tube in the area of the opening is essentially not expanded during puncturing but rather only bent. As a result, the length of the passage equals the radius of the opening in the case of an opening having, for example, a circular cross section.

The length of the passage, or the supporting surface of the tube at the opening, has little influence on the mechanical load of the connection between the tube and the collecting tube. A mechanical load on this connection results, for example, from thermal loads due to high compressive or tensile forces or expansions in the tubes or the collecting tube as well as bend overlays and upward bends or deformations of the tubes or the collecting tube.

This may cause damage, in particular leaks, at the connection between the tube and the collecting tube, which results in failure of the heat exchanger. This is generally associated with enormous expense, because it is not possible to repair the heat exchanger and the latter must therefore be replaced. In motor vehicles, in particular, leaking of the heat exchanger results in loss of cooling liquid, so that motor vehicle operation must be interrupted.

EP 0 990 868 B1 shows a generic heat exchanger. The thickness of the passages into which the tubes are introduced is equal to the thickness of the collecting tube wall outside the openings for introduction of the tubes. In addition, a contact between the passages and the tubes is produced only in a subarea of the passage in the direction of an axis of the openings. Only a small surface for supporting the tube on the passage is therefore present, so that only poor mechanical stability exists at this important connecting area between the tube and the collecting tube.

A heat exchanger is also known from DE 33 16 960 A1. The openings are punctured using a stamp. After the wall of the collecting tube has been punctured using the stamp, a portion of the passages is separated. As a result, the passages have a shorter length in the direction of the axis of the opening, so that a smaller contact surface forms between the tube and the passage. This has the disadvantage of poor mechanical stability between the tube and the collecting tube in the area of the passage.

DE 696 17 598 T2, which corresponds to U.S. Pat. No. 5,676,200, shows a generic heat exchanger. A collector plate has openings into which the ends of flat tubes are introduced, which are connected to the collector plate wall by soldering. To facilitate this connection, each hole is surrounded by a collar.

### SUMMARY OF THE INVENTION

It is therefore an object of the present invention is therefore to improve the mechanical stability between the tubes and the collecting tube in a heat exchanger, a motor vehicle air conditioning system and a method for manufacturing a heat exchanger. The heat exchanger and the motor vehicle air conditioning system should work economically during manufacture and reliably and safely during operation. In addition, it should be possible to carry out the method for manufacturing a heat exchanger easily and economically.

This object is achieved by a heat exchanger, in particular a heat exchanger for a motor vehicle, comprising a plurality of tubes, at least one collecting tube having a wall and openings in the wall, passages that are preferably annular in shape protruding from the wall in the axial direction of the openings, wherein the tubes are disposed partly at the passages in the area of one end of the tube, and a fluid-tight connection exists between the passages and tubes so that a fluid may be conducted through the tubes and the at least one collecting tube, also comprising at least one inlet opening for introducing the fluid and at least one outlet opening for discharging the fluid, wherein the thickness of the passages is less than the thickness of the wall of the collecting tube, in particular in the area of the openings. The tube or the opening has, for example, a circular, rectangular or square cross section.

In particular, the thickness of the passages decreases, preferably in a steady manner, from the beginning of the passages at the collecting tube wall to an end of the passages. The end of the passage may terminate either in the flow space of the collecting tube, i.e. it may terminate in the same manner as the end of the tube disposed in the collecting tube, or it may terminate outside the collecting tube, i.e. the end of the passage terminates in the direction diametrically opposed to the end of the tube disposed in the collecting tube.

In an embodiment, the thickness of the passages from the beginning at the base to a tip of the passages is at least 10% of the thickness of the wall, in particular in the area of the openings in the collecting tube, wherein the length of the tip of the passage is at least 10% of the thickness of the collecting tube wall, in particular in the area of the openings.

In a further embodiment, the thickness of the passages from a beginning at the base to 0.8 times the total length of the passage downstream from a tip is less than 0.9 times the thickness of the collecting tube wall, in particular in the area of the openings.

The maximum length of the passages is preferably greater than half the minimum diameter of the openings, in particular greater than 1.1 to 3 times half the minimum diameter thereof. The collecting tube wall in the subarea of the later opening is molded or bent to form the passage, and the passage is furthermore expanded. As a result, the maximum length of the passage is greater than half the minimum diameter of the opening. In a tube or opening having a rectangular cross section, the minimum diameter of the opening equals the width of the opening. The length of the passage is greater than half the width of the opening because the collecting tube wall is expanded during production of the passage. In a tube or opening having a circular cross section, half the minimum diameter thus equals the radius of the opening.

The tubes are connectable to the passages in an integral manner, preferably by soldering, so that they are fluid-tight, in particular liquid-tight.

In a further embodiment, the tubes and/or the at least one collecting tube are at least partially made of aluminum and/or aluminum alloys and/or plastic.

The collecting tube may also have a multi-part design. For example, the collecting tube may comprise a base made of metal, in particular, aluminum, and a box made of plastic. The box is designed to have, for example, a U-shaped cross section and is fastened in grooves in the base. The fluid-tight connection between the box and the base is established using a seal in the groove. As a result, a flow space forms between the base and the box. In a further embodiment, the collecting tube may comprise, for example, a base having an approximately U-shaped cross section and a cover. Both the base and the cover are manufactured from metal, in particular aluminum. A groove, with the aid of which the cover is connected to the base in a fluid-tight manner, is provided in the cover. The sealing action between the groove in the cover and the base is generally provided without a separate seal.

In a method according to the invention for manufacturing a heat exchanger comprising the steps: producing tubes; at least partially producing at least one collecting tube having a wall; puncturing a subarea of the wall of the at least one collecting tube to form openings having passages; introducing the tubes into the openings and connecting the tubes to the passages in a fluid-tight manner; the wall of the at least one collecting tube is expanded prior to puncturing holes in the subareas, so that the thickness of the passages is less than the thickness of the collecting tube wall in the subareas prior to expansion.

In a supplementary variant, the passages are expanded in such a way that the thickness of the passages from a beginning at the base to a tip of the passages is at least 10% of the thickness of the collecting tube wall, in particular in the area of the openings, the length of the tip of the passage being at least 10% of the thickness of the collecting tube wall, in particular in the area of the openings.

In a supplementary variant, the expansion of the wall of the at least one collecting tube in the subareas is carried out in a separate operation prior to puncturing. The expansion of the wall of the at least one collecting tube is thus carried out at a point in time prior to puncturing. The expansion may be carried out in a subarea of the wall of the at least one collecting tube in which the later opening will be produced, as well as beyond this area. If the expansion of the wall is carried out beyond this subarea, the part that is not expanded is viewed as the thickness of the collecting tube wall. A raised region is thus produced in the subarea during expansion of the wall.

Suitably, no material is removed from the wall, for example by stamping, i.e. the opening is produced exclusively by deforming, in particular by bending, the wall of the collecting tube.

In a supplementary variant, the expansion of the wall of the at least one collecting tube in the subareas is carried out with the aid of a tool other than a puncturing tool.

The section of the collecting tube on which the openings are created by stamping and puncturing may have different shapes. For example, the collecting tube may be straight or bent in this area.

A heat exchanger according to the invention, in particular a heat exchanger for a motor vehicle, comprises a plurality of tubes, at least one collecting tube having openings at which the tubes are at least partially disposed in the area of one end of the tubes and are connected to the openings in a fluid-tight manner, wherein the collecting tube comprises a base and a box and the openings are provided in the base and one end of the box is accommodated by a groove provided in the base for connecting the box to the base; the heat exchanger further comprises at least one inlet opening for introducing the fluid and at least one outlet opening for discharging the fluid, wherein an integral connection exists between an outside of the groove and the outside of the tubes, in particular between the seal and a tube axis of the tube. The integral connection preferably exists directly between the two outsides via a material, for example a soldering material, for establishing the integral connection.

In particular, the integral connection is a soldered and/or adhesive connection. To establish a soldered connection between the outside of the groove and the outside of the tube, in particular a narrow side of the tube, in the case of a tube having a rectangular cross section, there is a short distance between the outside of the groove and the outside of the tube, for example between 0 and 2 mm. As a result, the soldering material may rise in a capillary manner or be inserted during soldering in the area between the outside of the groove and the outside of the tube.

In a further embodiment, the outside of the groove is designed to be essentially parallel to the outside of the at least one tube in the area of the integral connection.

In an additional embodiment, preferably annular passages are provided in the axial direction of the openings, wherein the tubes are disposed at the passages in the area of one end of the tubes, and a fluid-tight connection exists between the passages and the tubes.

A motor vehicle air conditioning system or a motor vehicle includes the heat exchanger described in this application.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a view of a heat exchanger;

FIG. 2 shows a cross section A-A of a collecting tube having a tube of the heat exchanger according to FIG. 1 in a first specific embodiment;

FIG. 3 shows a cross section A-A of the collecting tube having the tube of the heat exchanger according to FIG. 1 in a second specific embodiment;

FIG. 4 show a partial longitudinal section of a base of the collecting tube according to FIG. 2 before openings for the tubes have been introduced;

FIG. 5 shows the partial longitudinal section of the base according to FIG. 4 after the openings have been introduced; and

FIG. 6 shows a view of the openings in the direction of an axis of the openings.

### DETAILED DESCRIPTION

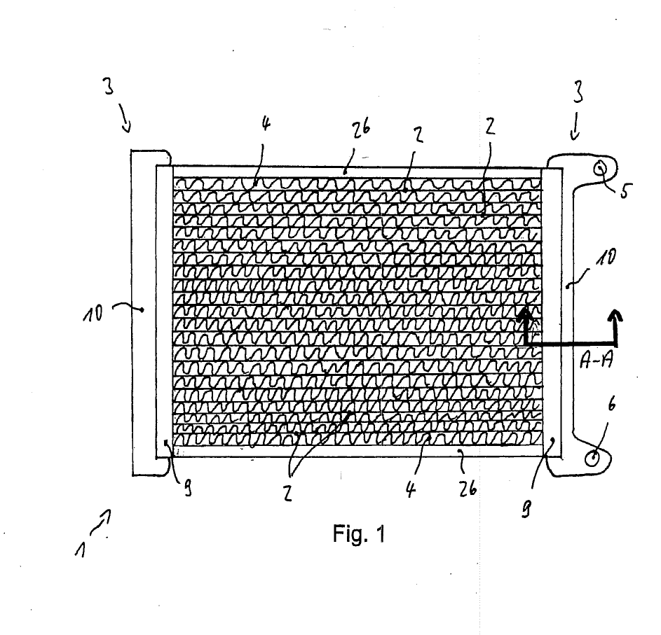

A view of a heat exchanger 1 is illustrated in FIG. 1. A plurality of tubes 2 is disposed between two collecting tubes 3. The top and bottom of the two collecting tubes 3 are each connected to each other with the aid of a connecting flange 26. Corrugated fins 4, which connect tubes 2 both mechanically and thermally, are provided between tubes 2. Corrugated fins 4 are used to enlarge the surface of heat exchanger 1 and thereby increase heat transfer.

An inlet opening 5 and an outlet opening 6 are provided in collecting tube 3 illustrated on the right in FIG. 1. Heat exchanger 1 is used to discharge the heat of cooling liquid in a motor vehicle to the environment. This cooling liquid flows into heat exchanger 1 through inlet opening 5 and flows out of heat exchanger 1 through outlet opening 6 in a cooled state. The two collecting tubes 3 each comprise a base 9 made of aluminum and a box 10 made of plastic in which inlet opening 5 and outlet opening 6 are also provided. Tubes 2 having a rectangular cross section empty into base 9 of collecting tube 3. This produces a hydraulic connection between the two collecting tubes 3 and tubes 2. An end of tube 2 terminates in flow space 25.

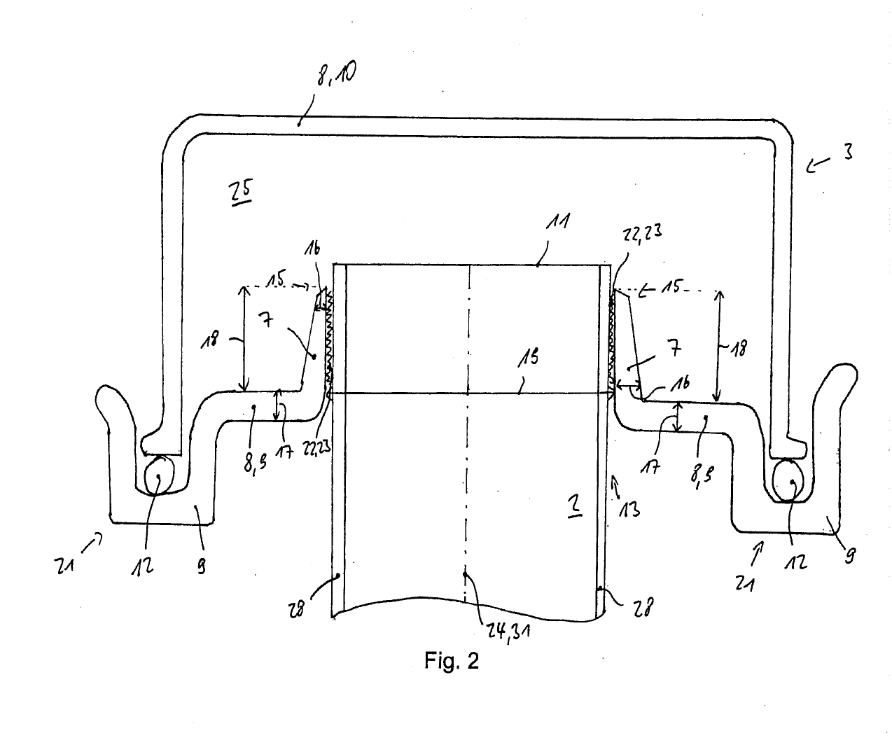

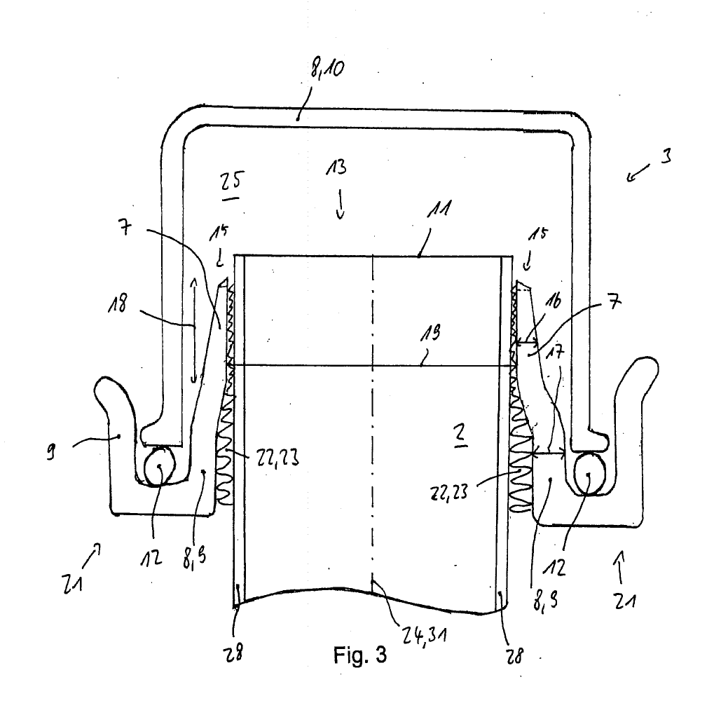

Base 9 and box 10 enclose a flow space 25 for the cooling liquid (FIGS. 2 and 3). Box 10 has an essentially U-shaped cross section. Base 9 is provided with a groove 21 in its cross section and at the ends. A seal 12 is disposed in groove 21. Seal 12, an elastic part, is used to connect base 9 to box 10 in a liquid-tight manner. Openings 13, in which tubes 2 are disposed by tube axes 31, are provided in base 9. An opening wall 14 of collecting tube 3 or of base 9 is deformed to form a passage 7. The end of passage 7 terminates in flow space 25 of collecting tube 3. Passage 7 thus represents former opening wall 14 of base 9 (FIG. 5), which was deformed to form passage 7.

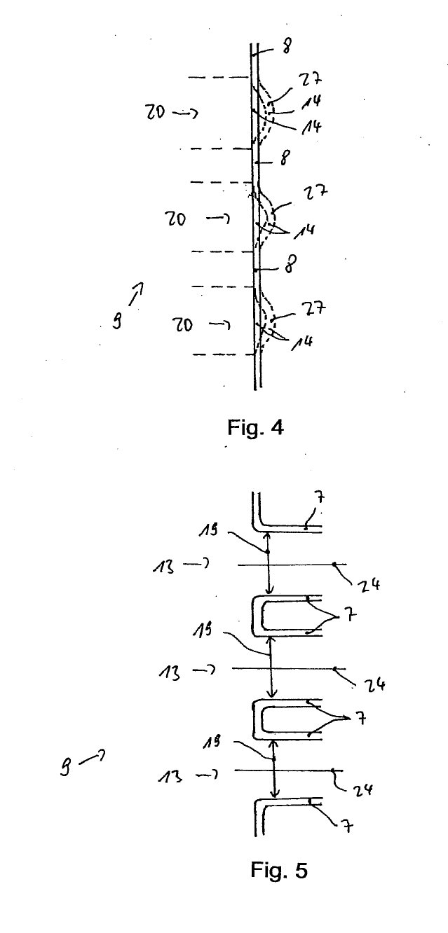

In producing openings 13 in base 9 (not illustrated), a raised region 27 is first provided in a subarea 20 of wall 8 of base 9, i.e. opening wall 14, using a stamp. Subarea 20 (FIG. 4) corresponds to a section of wall 8 which is deformed to form passage 7. Subarea 20 in FIG. 4 is the section of wall 8 which is provided within the broken line. Raised regions 27 are also illustrated by broken lines in FIG. 4. Based on this design of raised regions 27, wall 8 in subarea 20, which corresponds to later passage 7, is expanded in such a way that thickness 16 of passage 7 is less than thickness 17 of wall 8 of base 9 in the non-deformed area, i.e. outside subarea 20 or thickness 17 of opening walls 14. After the raised region is formed, a puncturing tool is used to produce opening 13. In doing this, wall 8 of base 9 is bent within subarea 20, resulting in the shape of passage 7 illustrated in FIGS. 2 and 5. Thickness 17 of wall 8 of base 9 is thus greater than thickness 16 of passage 9. Due to the puncturing process, a tip 15 is formed at the end of passage 7. Tip 15 is provided with an essentially triangular cross section. The thickness of passage 7 downstream from tip 15 is, for example, 20% to 30% of thickness 17 of wall 8 of base 9 prior to deformation.

An integral connection 22 (FIG. 2), which is designed as a soldered connection 23, exists between passage 7 and tube 2. In FIG. 2, the plane of projection is parallel to a plane of a wide side wall of tube 2 and perpendicular to a plane of a narrow side wall 28 of tube 2.

Length 18 of passage 7 is greater than half the minimum diameter 29 of opening 13 because wall 8 of base 9 has been expanded in subarea 20 during the formation of passage 7. Opening 13 is also provided with a rectangular design corresponding to the rectangular cross section of tube 2. Length 18 of passage 7 is greater than half the width of opening 13. A diameter 19 of opening 13 is slightly smaller than a corresponding outer diameter (not illustrated) of tube 2. This is necessary in order to provide a short distance between the outside of tube 2 and passages 7 within the entire area for the purpose of producing soldered connection 23. The distance between passage 7 and tube 2 is, for example, in the range between 0.2 mm and 1 mm, so that the soldering material may enter this gap in a capillary manner. If tubes 2 and base 9 are solder-plated and solder connections are created in a soldering furnace, no spacing is required.

The thickness of passage 7 decreases steadily from the beginning of passage 7 at wall 8 of base 9, or collecting tube 3, to the end of passage 7 at tip 15 of passage 7. This results from the production of passage 7. In producing raised region 27 of wall 8 in subarea 20, the central area is expanded to a greater degree than the edge area of subarea 20 in the vicinity of non-deformed or non-expanded wall 8 of base 9. Furthermore, passage 7 is also expanded during puncturing, and this expansion is also greater here in the area of the end of passage 7 than at the beginning of passage 7.

A partial longitudinal section of base 9 after subarea 20 has been punctured is illustrated in FIG. 5. Passages 7 are designed to be parallel to an axis 24 of opening 13.

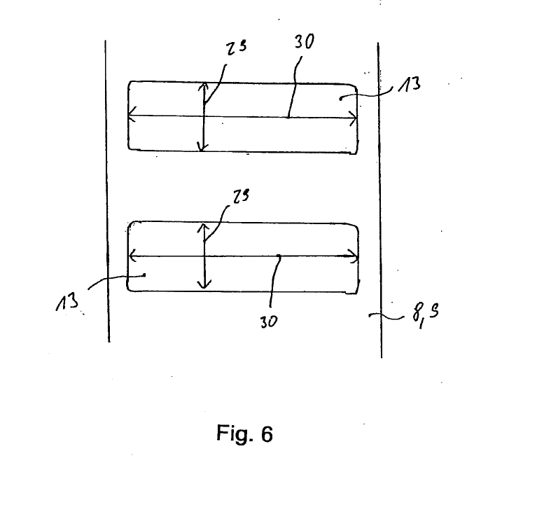

A view of openings 13 in the direction of an axis of the openings is illustrated in FIG. 6. Openings 13 are rectangular and have a minimum diameter 29 and a maximum diameter 30.

A second specific embodiment of collecting tube 3 of heat exchanger 1 is illustrated in FIG. 3. Only the differences from the first specific embodiment according to FIG. 2 are described below. Base 9 is designed in such a way that the outside of groove 21 and tube 2 are spaced a short distance apart in the range between 0 mm and 2 mm. An integral connection 22 provided as solder connection 23 exists in this gap having a thickness between 0 mm and 2 mm. The thickness of this gap between the outside of groove 21 and the outside of tube 2 is preferably 0.2 mm to 0.8 mm, so that the soldering material for soldered connection 23 is able to expand and rise in the gap in a capillary manner. Tube 2 is thus advantageously additionally connected to base 9, which increases the stability of the mechanical connection between tube 2 and base 9 or collecting tube 3. Mechanical loads, which result in particular from thermal deformations of heat exchanger 1, may thus be better absorbed. Damage to heat exchanger 1 resulting from damage to the connection between tube 2 and collecting tube 3 may be reduced thereby.

On the whole, substantial advantages are associated with heat exchanger 1 according to the invention. In producing passage 7, passage 7 is expanded in such a way that length 18 of passage 7 is expanded in the direction of axis 24 of opening 13. This increases the contact surface between tube 2 and passage 7, which is designed as soldered connection 23. The mechanical loads on the connection between tube 2 and passage 7, which result in particular from thermal deformations of heat exchanger 1, may thus be more easily absorbed. Resulting damage to heat exchanger 1, for example leaks at the connection between tube 2 and passage 7, may thus be substantially reduced. The larger contact surface thus results in a larger mounting surface and supporting surface for tube 2 at passage 7. As a result, the reliability of a heat exchanger 1 according to the invention and a motor vehicle air conditioning system according to the invention may be significantly increased.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat exchanger for a motor vehicle, the heat exchanger comprising:
a plurality of tubes;
at least one collecting tube having a wall and openings in the wall;
passages that are configured to protrude from the wall in an axial direction of the openings and are configured to be provided at the openings;
tubes disposed partially at the passages in an area of one end of the tubes, a fluid-tight connection being formed between the passages and the tubes;
at least one inlet opening configured to introduce a fluid; and
at least one outlet opening configured to discharge the fluid,
wherein a thickness of the passages is less than a thickness of the wall in the area of the openings in the collecting tube.

2. The heat exchanger according to claim 1, wherein the thickness of the passages decreases in a steady manner from a beginning of the passages at the wall of the collecting tube to an end of the passages.

3. The heat exchanger according to claim 1, wherein the thickness of the passages from a beginning at the base to a tip of the passages is at least 10% of the thickness of the wall of the collecting tube in the area of the openings, and wherein the length of the tip of the passages is at least 10% of the thickness of the wall of the collecting tube in the area of the openings.

4. The heat exchanger according to claim 1, wherein the thickness of the passages from a beginning at the base to 0.8 times a total length of the passage downstream from a tip is less than 0.9 times the thickness of the wall of the collecting tube in the area of the openings.

5. The heat exchanger according to claim 1, wherein a maximum length of the passages is greater than half the minimum diameter of the openings or is greater than 1.1 to 3 times half the minimum diameter thereof.

6. A method for manufacturing a heat exchanger according to claim 1, the method comprising:
producing tubes;
at least partially producing at least one collecting tube having a wall;
puncturing a subarea of the wall of the at least one collecting tube to form openings having passages;
introducing the tubes into the openings;
connecting the tubes to the passages in a fluid-tight manner; and
expanding the wall of the at least one collecting tube in subareas to form raised regions prior to puncturing, so that the thickness of the passages is less than the thickness of the wall of the collecting tube in the subareas prior to expansion.

7. The method according to claim 6, wherein the passages are expanded such that the thickness of the passages from a beginning at the base to a tip of the passages is at least 10% of the thickness of the wall of the collecting tube in the area of the openings, and wherein the length of the tip of the passages is at least 10% of the thickness of the wall of the collecting tube in the area of the openings.

8. The method according to claim 6, wherein the expansion of the wall of the at least one collecting tube in the subareas is carried out in a separate operation prior to puncturing.

9. The method according to claim 6, wherein the expansion of the wall of the at least one collecting tube in the subareas is carried out using a tool other than the puncturing tool and/or no material is removed from the wall by punching.

10. A heat exchanger for a motor vehicle, the heat exchanger comprising:
a plurality of tubes;
at least one collecting tube having openings at which the tubes are partially disposed in the area of one end of the tubes and are connectable to the openings in a fluid-tight manner, the collecting tube comprising a base and a box, the openings being provided in the base, and one end of the box is accommodated by a groove provided in the base for connecting the box to the base;
at least one inlet opening configured to introduce a fluid; and
at least one outlet opening configured to discharge the fluid,
wherein an integral connection exists between an outside of the groove and the outside of the tubes between a seal and a tube axis of the tube.

11. The heat exchanger according to claim 10, wherein the integral connection is a soldered and/or adhesive connection.

12. The heat exchanger according to claim 10, wherein the outside of the groove in the area of the integral connection is designed to be essentially parallel to the outside of the tubes.

13. The heat exchanger according to claim 10, wherein annular passages are arranged in the axial direction of the openings, wherein the tubes are disposed at the passages in the area of one end of the tubes, and wherein a fluid-tight connection exists between the passages and the tubes.

14. A motor vehicle air conditioning system, wherein the motor vehicle air conditioning system includes a heat exchanger according to claim 1.
